(19) United States
(12) Patent Application Publication
(10) Pub. No.: US 2019/0362013 A1
(43) Pub. Date: Nov. 28, 2019

(54) AUTOMATED SOURCING USER INTERFACE

(71) Applicant: Microsoft Technology Licensing, LLC, Redmond, WA (US)

(72) Inventors: Monica Marie Lewis, Menlo Park, CA (US); Neha Jain, Sunnyvale, CA (US); Heyang Liu, Santa Clara, CA (US); Huanyu Zhao, Fremont, CA (US); Roll Jean Cheng, San Jose, CA (US); Eva Chau, Mountain View, CA (US)

(21) Appl. No.: 15/989,999

(22) Filed: May 25, 2018

(51) Int. Cl. G06F 17/30; G06F 9/451; G06Q 10/10; G06N 99/00

(52) U.S. Cl. CPC G06F 17/30554; G06F 17/30398; G06N 99/005; G06F 17/30867; G06Q 10/1053; G06F 9/451

(57) ABSTRACT

In an example embodiment, a selection of a first user profile by a viewer of the graphical user interface is received, and one or more attribute fields of the first user profile are identified as query fields. Then a query is automatically generated using the one or more query fields. A search is performed for additional user profiles using the automatically generated query, resulting in one or more additional user profile results. Then the graphical user interface is caused to display summaries of a plurality of the additional user profile results across the display. Then the graphical user interface is caused to render a button that, when selected by the viewer of the graphical user interface, causes a communication to be generated and sent to each of the displayed additional user profile results.

### TECHNICAL FIELD

The present disclosure generally relates to computer technology for solving technical challenges in quickly identifying search results and presenting the search results efficiently and effectively in a user interface. More specifically, the present disclosure relates to performing automated sourcing by automatically performing searches for online records of candidates based on one or more searches already performed, and displaying these additional online records simultaneously on a screen of a user interface.

### BACKGROUND

The rise of the Internet has occasioned two related phenomena: the increase in the presence of online systems with connected members that have corresponding member profiles visible to large numbers of people, and the increase in use of these online systems for job searches, by applicants, employers, social referrals, and recruiters. Employers and recruiters attempting to connect candidates and employers, or refer them to a suitable position (e.g., job title), often perform searches on the online systems to identify candidates who have relevant qualifications that make them good candidates for whatever job opening the employers or recruiters are attempting to fill. The employers or recruiters then can contact these candidates to see if they are interested in applying for the job opening.

Traditional querying of online systems for candidates involves the employer or recruiter entering one or more search terms to manually create a query. A key challenge in a search for candidates (e.g., talent search) is to translate the criteria of a hiring position into a search query that leads to desired candidates. To fulfill this goal, the searcher typically needs to understand which skills are typically required for the position (e.g., job title), what are the alternatives, which companies are likely to have such candidates, which schools the candidates are most likely to graduate from, etc. Moreover, this knowledge varies over time. Furthermore, some attributes, such as the culture of a company, are not easily entered into a search box as query terms. As a result, it is not surprising that, even for experienced recruiters, many search trials are often required in order to obtain an appropriate query that meets the recruiters' search intent. Additionally, small business owners do not have the time to navigate through and review large numbers of candidates.

Furthermore, presentation of search results in response to recruiter searches can be challenging. Typically, results are presented in a manner similar to traditional online web search results, namely, the results are ranked and results presented vertically with the viewer scrolling through results. As such, normally no more than one or two results are visible at a time. This presents a challenge to a user of the user interface, who must scroll through the screens multiple times to select candidates he or she wishes to contact.

### BRIEF DESCRIPTION OF THE DRAWINGS

Some embodiments of the technology are illustrated, by way of example and not limitation, in the figures of the accompanying drawings.

FIG. 1 is a block diagram illustrating a client-server system, in accordance with an example embodiment.

FIG. 2 is a block diagram showing the functional components of a social networking service, including a data processing block referred to herein as a search engine, for use in generating and providing search results for a search query, consistent with some embodiments of the present disclosure.

FIG. 3 is a block diagram illustrating an application server block of FIG. 2 in more detail, in accordance with an example embodiment.

FIG. 4 is a screen capture illustrating a multi-record search result display user interface 400, in accordance with an example embodiment.

FIG. 5 is a flow diagram illustrating a method for creating a deep embedded representation of social network entities, in accordance with an example embodiment.

FIG. 6 is a block diagram illustrating a representative software architecture, which may be used in conjunction with various hardware architectures herein described.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

In an example embodiment, multiple technological innovations are provided to improve automated sourcing by retrieving computer records related to job candidates automatically and presenting the results in a novel user interface that improves the efficiency of a recruiter or other user interface user to select and communicate with corresponding job candidates. In some example embodiments, this process is further improved by providing recruiters with the ability to select certain fields of candidate records as being “important” to a particular search, and the automated sourcing functionality can then utilize these important fields when retrieving additional candidate records.

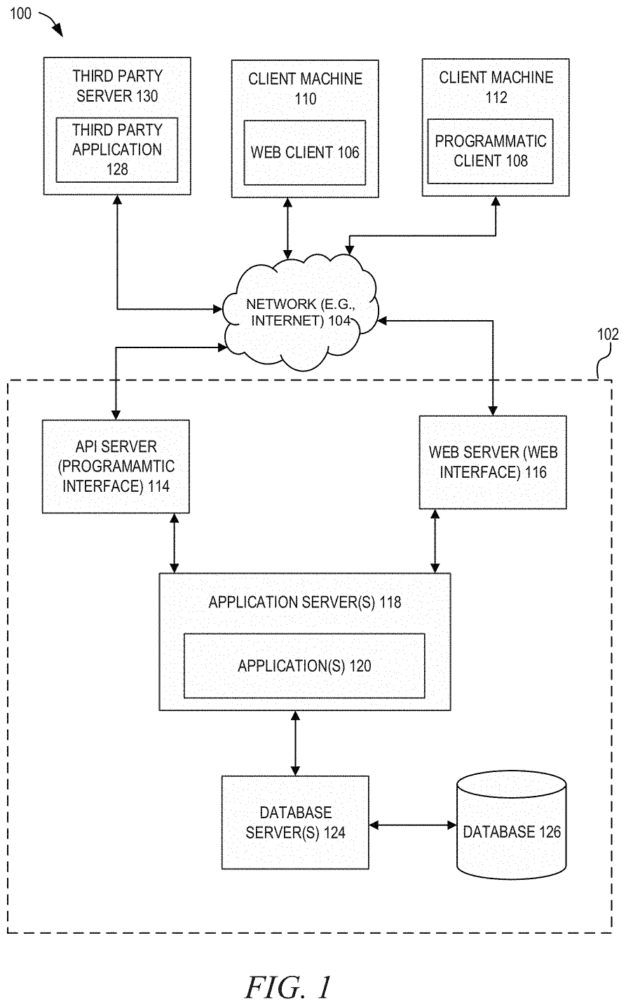

FIG. 1 is a block diagram illustrating a client-server system 100, in accordance with an example embodiment. A networked system 102 provides server-side functionality via a network 104 (e.g., the Internet or a wide area network (WAN)) to one or more clients. FIG. 1 illustrates, for example, a web client 106 (e.g., a browser) and a programmatic client 108 executing on respective client machines 110 and 112.

An API server 114 and a web server 116 are coupled to, and provide programmatic and web interfaces respectively to, one or more application servers 118. The application server(s) 118 host one or more applications 120. The application server(s) 118 are, in turn, shown to be coupled to one or more database servers 124 that facilitate access to one or more databases 126. While the application(s) 120 are shown in FIG. 1 to form part of the networked system 102, it will be appreciated that, in alternative embodiments, the application(s) 120 may form part of a service that is separate and distinct from the networked system 102.

Further, while the client-server system 100 shown in FIG. 1 employs a client-server architecture, the present disclosure is, of course, not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the application(s) 120 via the programmatic interface provided by the API server 114.

FIG. 1 also illustrates a third-party application 128, executing on a third-party server 130, as having programmatic access to the networked system 102 via the programmatic interface provided by the API server 114. For example, the third-party application 128 may, utilizing information retrieved from the networked system 102, support one or more features or functions on a website hosted by a third-party. The third-party website may, for example, provide one or more functions that are supported by the relevant applications 120 of the networked system 102.

In some embodiments, any website referred to herein may comprise online content that may be rendered on a variety of devices including, but not limited to, a desktop personal computer (PC), a laptop, and a mobile device (e.g., a tablet computer, smartphone, etc.). In this respect, any of these devices may be employed by a user to use the features of the present disclosure. In some embodiments, a user can use a mobile app on a mobile device (any of the client machines 110, 112 and the third-party server 130 may be a mobile device) to access and browse online content, such as any of the online content disclosed herein. A mobile server (e.g., API server 114) may communicate with the mobile app and the application server(s) 118 in order to make the features of the present disclosure available on the mobile device. In some embodiments, the networked system 102 may comprise functional components of a social networking service.

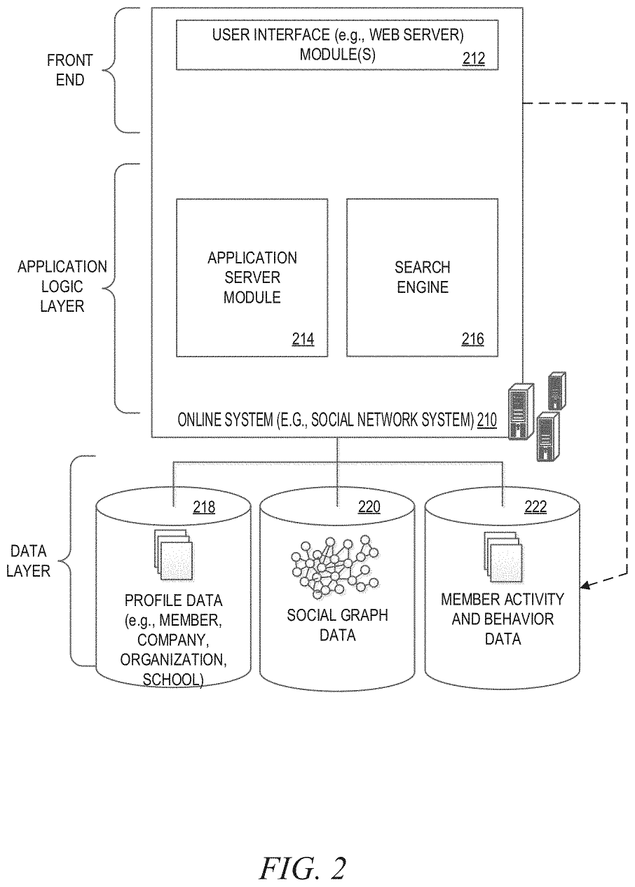

FIG. 2 is a block diagram illustrating components of an online system 210 (e.g., a social network system hosting a social networking service), according to some example embodiments. The online system 210 is an example of the networked system 102 of FIG. 1. In certain embodiments, the online system 210 may be implemented as a social network system. As illustrated in FIG. 2, the functional components of a social network system may include a data processing block referred to herein as a search engine 216, for use in generating and providing search results for a search query, consistent with some embodiments of the present disclosure. In some embodiments, the search engine 216 may reside on the application server(s) 118 in FIG. 1. However, it is contemplated that other configurations are also within the scope of the present disclosure.

As shown in FIG. 2, a front end may comprise a user interface module or block (e.g., a web server 116) 212, which receives requests from various client computing devices, and communicates appropriate responses to the requesting client devices. For example, the user interface module(s) 212 may receive requests in the form of Hypertext Transfer Protocol Secure (HTTPS) requests or other web-based API requests. In addition, a member interaction detection functionality is provided by the online system 210 to detect various interactions that members have with different applications 120, services, and content presented. As shown in FIG. 2, upon detecting a particular interaction, such as a member interaction, the online system 210 logs the interaction, including the type of interaction and any metadata relating to the interaction, in a member activity and behavior database 222.

An application logic layer may include the search engine 216 and one or more various application server module(s) 214 which, in conjunction with the user interface module(s) 212, generate various user interfaces (e.g., web pages) with data retrieved from various data sources in a data layer. In some embodiments, individual application server modules) 214 are used to implement the functionality associated with various applications 120 and/or services provided by the social networking service, Member interaction detection happens inside the user interface module(s) 212, the application server module(s) 214, and the search engine 216, each of which can fire tracking events in the online system 210. That is, upon detecting a particular member interaction, any of the user interface module(s) 212, the application server module(s) 214, and the search engine 216 can log the interaction, including the type of interaction and any metadata relating to the interaction, in a member activity and behavior database 222.

As shown in FIG. 2, the data layer may include several databases 126, such as a profile database 218 for storing profile data, including both member profile data and profile data for various organizations (e.g., companies, research institutes, government organizations, schools, etc.). Consistent with some embodiments, when a person initially registers to become a member of the social networking service, the person will be prompted to provide some personal information, such as his or her name, age (e.g., birth date), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 218. Similarly, when a representative of an organization initially registers the organization with the social networking service, the representative may be prompted to provide certain information about the organization. This information may be stored, for example, in the profile database 218, or another database (not shown). In some embodiments, the profile data may be processed (e.g., in the background or offline) to generate various derived profile data. For example, if a member has provided information about various job titles that the member has held with the same organization or different organizations and for how long, this information can be used to infer or derive a member profile attribute indicating the member's overall seniority level, or seniority level within a particular organization. In some embodiments, importing or otherwise accessing data from one or more externally hosted data sources may enrich profile data for both members and organizations. For instance, with organizations in particular, financial data may be imported from one or more external data sources and made part of an organization's profile. This importation of organization data and enrichment of the data will be described in more detail later in this document.

Once registered, a member may invite other members, or be invited by other members, to connect via the social networking service. A ‘connection’ may constitute a bilateral agreement by the members, such that both members acknowledge the establishment of the connection. Similarly, in some embodiments, a member may elect to ‘follow’ another member. In contrast to establishing a connection, ‘following’ another member typically is a unilateral operation and, at least in some embodiments, does not require acknowledgement or approval by the member that is being followed. When one member follows another, the member who is following may receive status updates (e.g., in an activity or content stream) or other messages published by the member being followed, or relating to various activities undertaken by the member who is being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph in a social graph database 220.

As members interact with the various applications 120, services, and content made available via the social networking service, the members' interactions and behavior (e.g., content viewed, links or buttons selected, messages responded to, etc.) may be tracked, and information concerning the members' activities and behavior may be logged or stored, for example, as indicated in FIG. 2, by the member activity and behavior database 222. This logged activity information may then be used by the search engine 216 to determine search results for a search query.

In some embodiments, the databases 218, 220, and 222 may be incorporated into the database(s) 126 shown in FIG. 1. However, other configurations are also within the scope of the present disclosure.

Although not shown, in some embodiments, the online system 210 provides an API block via which applications 120 and services can access various data and services provided or maintained by the social networking service. For example, using an API, an application may be able to request and/or receive one or more candidate selections. Such applications 120 may be browser-based applications 120, or may be operating system specific. In particular, some applications 120 may reside and execute (at least partially) on one or more mobile devices (e.g., phone or tablet computing devices) with a mobile operating system. Furthermore, while in many cases the applications 120 or services that leverage the API may be applications 120 and services that are developed and maintained by the entity operating the social networking service. Nothing other than data privacy, concerns prevents the API from being provided to the public or to certain third parties under special arrangements, thereby making the candidate selections available to third-party applications 128 and services.

Although the search engine 216 is referred to herein as being used in the context of a social networking service, it is contemplated that it may also be employed in the context of any website or online services. Additionally, although features of the present disclosure are referred to herein as being used or presented in the context of a web page, it is contemplated that any user interface view (e.g., a user interface on a mobile device or on desktop software) is within the scope of the present disclosure.

In an example embodiment, when member profiles are indexed, forward search indexes are created and stored. The search engine 216 facilitates the indexing and searching for content within the social networking service, such as the indexing and searching for data or information contained in the data layer, such as profile data (stored, e.g., in the profile database 218), social graph data (stored, e.g., in the social graph database 220), and member activity and behavior data (stored, e.g., in the member activity and behavior database 2). The search engine 216 may collect, parse, and/or store data in an index or other similar structure to facilitate the identification and retrieval of information in response to received queries for information. This may include, but is not limited to, forward search indexes, inverted indexes, N-gram indexes, and so on.

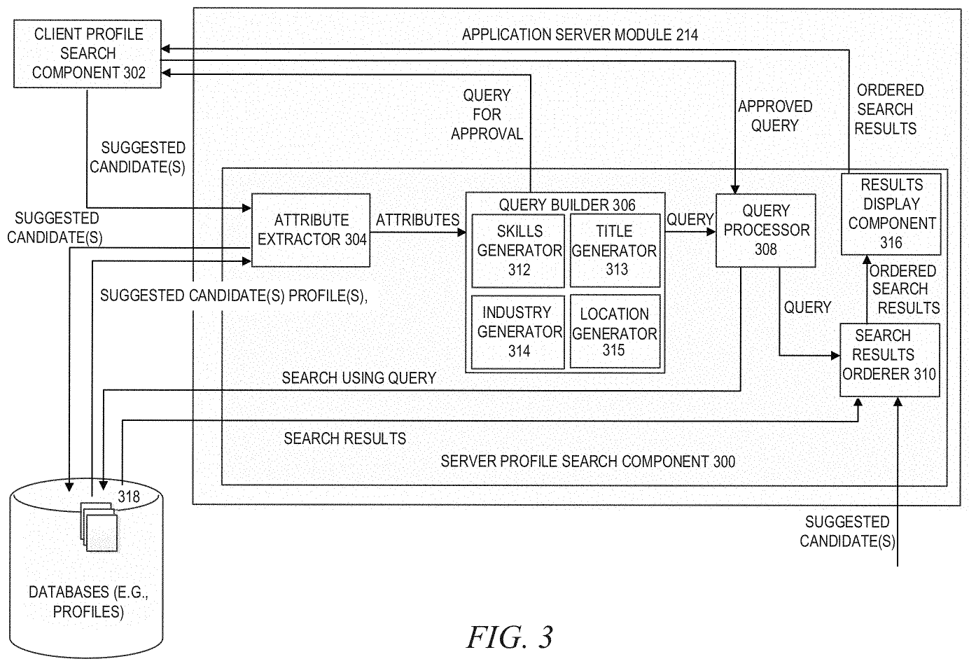

FIG. 3 is a block diagram illustrating the application server block or module 214 of FIG. 2 in more detail. While in many embodiments, the application server module 214 will contain many subcomponents used to perform various different actions within the online system 210, in FIG. 3 only those components that are relevant to the present disclosure are depicted. Here, a server profile search component 300 works in conjunction with a client profile search component 302 to perform one or more searches on member profiles stored in, for example, the profile database 218 of FIG. 2. The server profile search component 300 may be, for example, part of a larger software service that provides various functionality to employers or recruiters. The client profile search component 302 may include a user interface and may be located on a client device. For example, the client profile search component 302 may be located on a searcher's mobile device or desktop/laptop computer. In some example embodiments, the client profile search component 302 may itself be, or may be a part of, a stand-alone software application on the client device. In other example embodiments, the client profile search component 302 is a web page and/or web scripts that are executed inside a web browser on the client device. Regardless, the client profile search component 302 is designed to accept input from the searcher and to provide visual output to the searcher.

In an example embodiment, the input from the client profile search component 302 includes an identification of one or more suggested candidates for a job opening. This identification may be accomplished in many ways. In some example embodiments, the input may be an explicit identification of one or more member profiles stored in the profile database 218. This explicit identification may be determined by the searcher, for example, browsing or otherwise locating specific suggested candidate profiles that the searcher feels match a position the searcher is currently seeking to till. For example, the searcher may know the identity of individuals on a team in which the open position is available, and may navigate to and select the profiles associated with those team individuals. In another example embodiment, the searcher may create one or more hypothetical ‘suggested candidate’ profiles and use those as the input. In another example embodiment, the searcher may browse or search profiles in the profile database 218 using traditional browsing or searching techniques. In some example embodiments, the explicit identification may be provided by the job poster.

The server profile search component 300 may contain an attribute extractor 304. The attribute extractor 304 may be implemented as a system component or block that is configured to extract one or more attributes from one or more profiles of one or more suggested candidates (i.e., one or more suggested candidate member profiles). For instance, the attribute extractor 304 may be configured to extract raw attributes, including, for example, skills, companies, titles, schools, industries, etc., from the profiles of the one or more suggested candidates. These raw attributes are then passed to a query builder 306. Notably, the query builder 306 is not configured to use attributes obtained from other data sources other than those related to the suggested candidates, such as profiles and/or usage information about the candidates (e.g., how active they are on the social networking service, whether they have been identified as an active job seeker from their usage of the social networking service, etc.). Examples of other data sources which the query builder 306 is not drawing from include the job posting or details about the potential employer. By focusing on the candidates themselves and attributes about the candidates, this enables the system to more efficiently form queries than if other sources were considered. The insight here is that the searcher knows more about the type of candidate he or she is looking for than an automated system extracting information about the job posting or employer would, and thus the searcher's selection of certain candidates is a much more reliable signal as to appropriate attributes for a candidate than information about the job posting or employer.

The query builder 306 may be implemented as a system component or block that is configured to aggregate raw attributes across one or more selected candidates, expand them to similar attributes, and then select the top attribute values that most closely represent the suggested candidates.

In an example embodiment, the query builder 306 is hard-wired to examine only particular attributes in fields of selected candidate profiles. These attributes include industry, location, current title, and one or more skills. These attributes may be called “query fields” as they are the attributes that will be used to automatically generate the query. Various embodiments are envisioned where various combinations of these particular attributes are used, whereas others may not be used. It should also be noted that, with respect to skills, in some embodiments, only the first skill in candidate profiles is used, but in other embodiments if selecting the first skill does not yield a search query producing enough results, the second skill in the candidates' profiles may be used and a new query formed and executed based on the second skill(s).

In other example embodiments, the query builder 306 is not hard-wired and instead the searcher is able to identify, in the selected candidate profiles, the attributes that the searcher finds appropriate. These attributes are then used to generate the query.

In some example embodiments, a machine learning algorithm may be used to identify the query fields, and potentially other information used to automatically generate the query. A machine learned model may be trained using a machine learning algorithm. The machine learning algorithm may be selected from among many different potential supervised or unsupervised machine learning algorithms. Examples of supervised learning algorithms include artificial neural networks, Bayesian networks, instance-based learning, support vector machines, random forests, linear classifiers, quadratic classifiers, k-nearest neighbor, decision trees, and hidden Markov models. Examples of unsupervised learning algorithms include expectation-maximization algorithms, vector quantization, and information bottleneck method. Training data may be fed into the machine learning algorithm to train weights applied to one or more features extracted from the training data. Those learned weights may then be used as part of the model on features extracted from runtime data, such as the fields of a user profile or usage information by the viewer, such as past interactions with the graphical user interface (e.g., which users the viewer previously communicated with).

Optionally, after a candidate query is generated, in an example embodiment, the generated query may be shown to the searcher via the client profile search component 302 and the searcher may have the opportunity to edit the generated query. This may include adding or removing some attributes, such as skills and companies, to or from the query. As part of this operation, a query processor 308 may perform a search on the query and present raw results to the searcher via the client profile search component 302. These raw results may be useful to the searcher in determining how to edit the generated query.

Referring back to the query builder 306, given the raw attributes from the profiles (and possibly usage data) of the suggested candidates, the query builder 306 generates a query containing similar attributes. As shown in FIG. 3, the query builder 306 may comprise a skills generator 312, a title generator 313, an org./co. generator 314, and a location generator 315. The skills generator 312 is designed to generate skills similar to that of the skill(s) of the selected candidates to be added to the generated query. The title generator 313 is designed to generate job titles and roles similar to the titles of the selected candidates to be added to the generated query. The industry generator 314 is designed to generate industries similar to the industries of the selected candidates to be added to the generated query. The location generator 315 is designed to generate geographic locations (e.g., cities, metropolitan areas) similar to the locations of the selected candidates to be added to the generated query.

The social networking service may allow members to add skills to their profiles. Typical examples of skills that, for example, an information technology (IT) recruiter might search could be ‘search,’ ‘information retrieval,’ ‘machine learning,’ etc. Members may also endorse skills of other members in their network by, for example, asserting that the member does indeed have the specified skills. Thus, skills may be an important part of members' profiles that showcase their professional expertise. A technical challenge encountered, however, is that suggested candidates may not explicitly list all of the skills they have on their profiles. Additionally, some of their skills may not be relevant to their core expertise. For example, an IT professional may list ‘nonprofit fundraising’ as a skill.

To overcome these challenges, in some example embodiments, expertise scores for the suggested candidate may be estimated based on explicit skills (skills the suggested candidate has explicitly listed in a member profile or resume) as well as implicit skills (skills the suggested candidate is likely to have, but has not explicitly linked).

Certain embodiments determine a candidate's skill strength by determining the candidate's strongest skills. These embodiments determine a given candidate's skill strength based on member profile attributes such as, but not limited to, numbers of endorsements for skills, inferences based on related skills (e.g., if a candidate knows Enterprise JavaBeans/EJB, JUnit, Eclipse, and Java 2 Platform, Enterprise Edition (J2EE), then an inference may be made that the candidate has strong Java skills), the member's profile text, and the member's interactions with a social networking service (e.g., an online professional network), and an expertise score.

In some embodiments, probabilities of occurrences of clusters of skills may be determined for suggested candidates. The suggested candidates can be conceptualized as a training dataset used to determine probabilities of occurrences of skills amongst suggested candidates for a given organization. In an example, such skills possessed by suggested candidates may be correlated with titles (e.g., software developer or software engineer). For instance, for a given title, (e.g., software developer) and its related titles (e.g., software engineer), skills can be clustered. For the given title, clusters of the skills may follow a power law distribution, with few of the skills being highly prevalent (i.e., having relatively higher probabilities of occurrences) amongst the population of suggested candidates, followed by a heavy tail of less prevalent skills with lower probabilities of occurrences.

Some embodiments may identify distributions of numbers of unique explicit skills observed among suggested candidates. For example, on a per member basis, the average number of explicit skills for a member may be identified, and the distribution may show that about 50% of the member profiles have more than a certain number of skills (e.g., 20 skills), In an embodiment, a skill reputation score can be used to identify relevant and important skills amongst those associated with a member's profile and a given title. In an embodiment, a user interface can present coverage of regional data for a given title identifier (title ID) in standardized data.

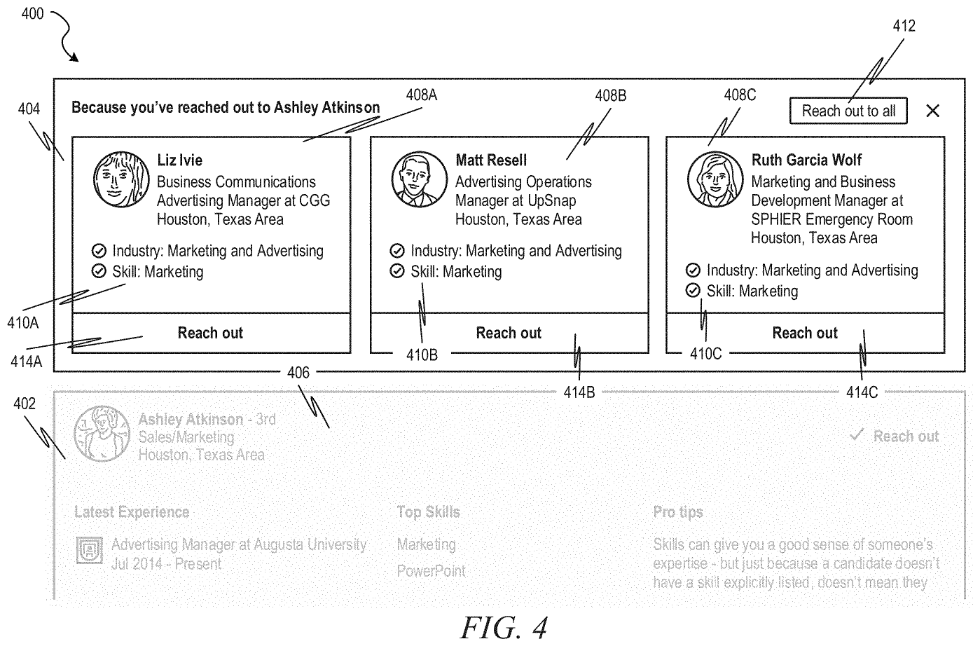

FIG. 4 is a screen capture illustrating a multi-record search result display user interface 400, in accordance with an example embodiment. The multi-record search result display user interface 400 includes a selected candidate portion 402 and an additional candidates portion 404. The selected candidate portion 402 displays details about one or more candidates previously selected by a user of the multi-record search result display user interface 400. In this case, the candidate profile 406 was previously displayed to the user and the user selected to “reach out” to (i.e., communicate with) the corresponding candidate, possibly by selecting a “reach out” button on a previous screen, causing an automated message to be populated and/or sent to the corresponding candidate. At this stage, the candidate profile 404 appears greyed out as the user has already reached out to the candidate.

In response to this reaching out, the system has determined that this candidate has been selected. As such, attributes from the corresponding candidate's profile are extracted and used to perform an automated sourcing search, producing a plurality of search results in the form of candidate records 408A-408C, Notably, more than one of these candidate records 408A-408C are displayed in the additional candidates portion 404. Here, candidate records 408A-408C are depicted. Notably, these candidate records 408A-408C are condensed versions of the profiles of the corresponding candidates, formatted in a manner that makes them ideal for horizontal display as opposed to vertical display. Thus, candidate records 408A-408C are displayed side-by-side. One advantage to this is that more candidate records 408A-408C can be viewed on the screen at a time than if they were displayed vertically. Another advantage is that this means that corresponding fields of the candidate records 408A-408C are displayed on or near the same row in all the candidate records 408A-408C in a manner that allows the user to scan from side to side and easily compare similar fields. Yet another advantage of this horizontal display is that it also becomes easier to compare which attributes produced the match between 408A-408C. Another advantage is that this horizontal display makes it easier to reach out to multiple candidates at a time.

Specifically, in an example embodiment, display of candidate search results involves not just the display of candidates and candidate attributes but also the display of the reasons why they are considered a match. In FIG. 4, each of the candidate records 408A-408C includes indications 410A-410C of which attributes were found to be matching (in this case, it just so happens that all the candidates matched based on industry and skill but in other cases some of the candidates may not have matched on one of these attributes but matched on other attributes).

In an example embodiment, prior to display of the candidate records 408A-408C the candidate records 408A-408C returned from the arch may be filtered to, for example, remove candidate records 408A-408C that the user has previously seen or rated, or candidates whose current position is already with a hiring company for which the search is being performed.

Additionally, in the example embodiment in FIG. 4, exactly three candidate records 408A-408C are displayed. This is by design, as the system in this embodiment is designed to display exactly three results in order to maximize the user interface benefits described earlier. In other example embodiments, this number may be different and, in some example embodiments, this number may be dynamically determined based on various criteria, such as screen size, relevance of results, size of important fields of the candidate records 408A-408C, etc. A button 412 may be provided to allow the viewer to communicate with all of the users corresponding to candidate records 408A-408C at once or, alternatively, the viewer can select one or more of buttons 414A-414C to send communications individually.

It should be noted that in cases where there are too many matched candidate records to display simultaneously (e.g., more than three), a subset of the matched candidate records can be dynamically determined based on various criteria, such as screen size, relevance of candidate records, size of important fields of the candidate records, etc.

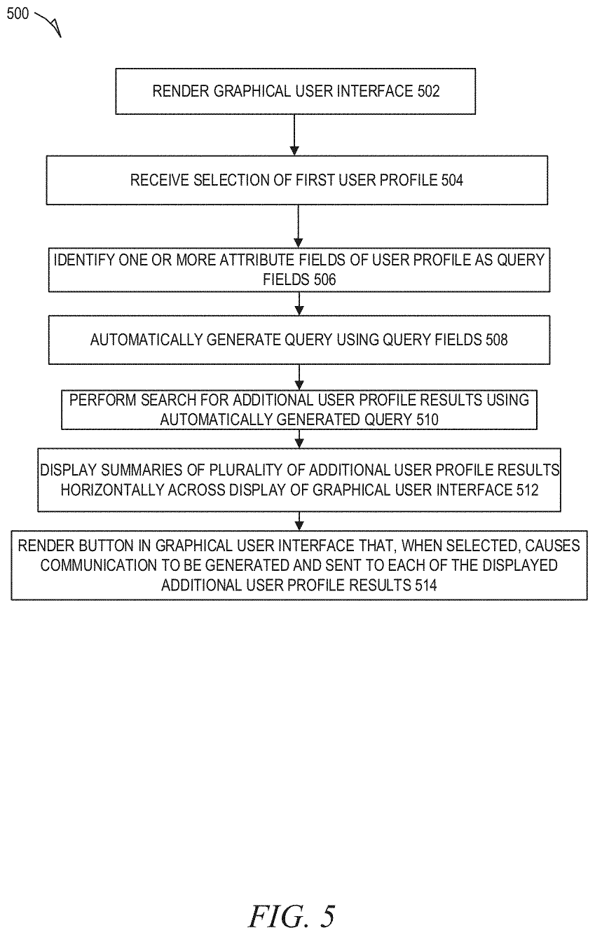

FIG. 5 is a flow diagram illustrating a method 500 for rendering a graphical user interface on a computer system, in accordance with an example embodiment. At operation 502, a graphical user interface is rendered on a display of a computer system. At operation 504, a selection of a first user profile is received, via the graphical user interface, from a viewer of the graphical user interface. The first user profile contains one or more attribute fields identifying attributes of a corresponding first user in a social networking service. At operation 506, one or more of the one or more attribute fields are identified as query fields. As described earlier, in some example embodiments, these query fields may be predetermined or “hard-wired” to include attributes selected from location, title, top skill(s) and industry. In other example embodiments, these query fields may be identified by the viewer, who selects particular query fields of interest in the graphical user interface. In other example embodiments, these query fields may be identified by a machine learned model which is designed to predict query fields of importance to the viewer based on, for example, past usage information about how the viewer previously interacted with the graphical user interface. It should be noted that in an example embodiment these attribute fields are only identified when a candidate presented to the viewer was rated positively (e.g., the user “favorited” or “reached out” to the candidate, or the like)

At operation 508, a query is automatically generated using the one or more query fields. In some example embodiments, the query may be automatically, generated using only the one or more query fields (excluding, for example, information about a corresponding job posting where the user profiles are profiles of candidates who may have interest in applying for a job specified by the job posting.

At operation 510, a search for additional user profiles is performed using the automatically generated query, resulting in one or more additional user profile results. At operation 512, summaries of a plurality of the additional user profile results are displayed horizontally across the display in the graphical user interface. At operation 514, a button 412 is rendered in the graphical user interface that, when selected by the viewer of the graphical user interface, causes a communication to be generated and sent to each of the displayed additional user profile results. This button allows the viewer to reach out to all similar candidates in one click.

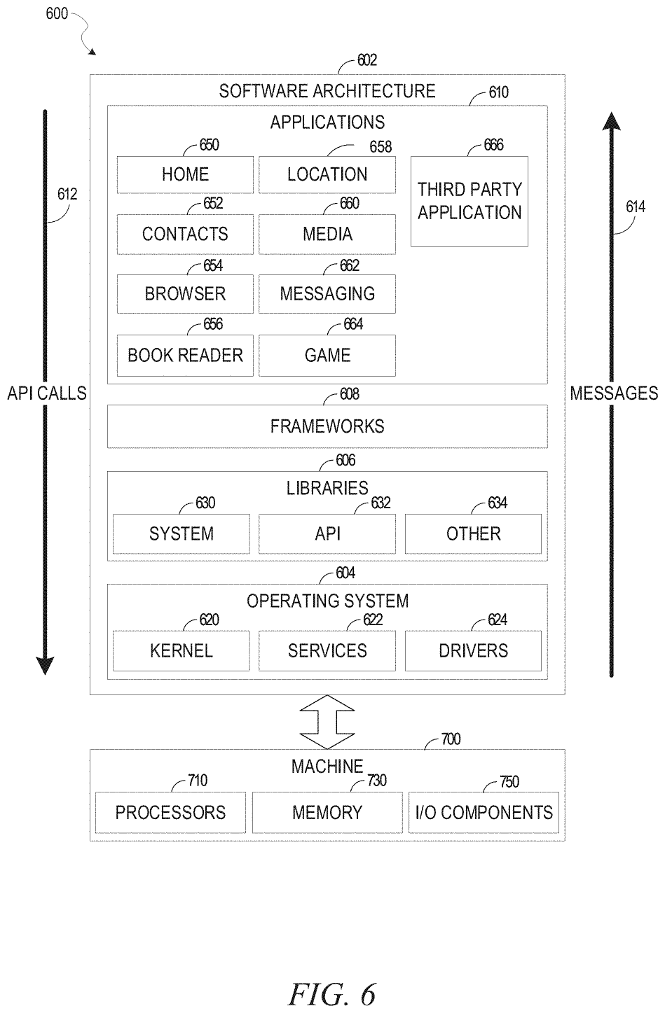

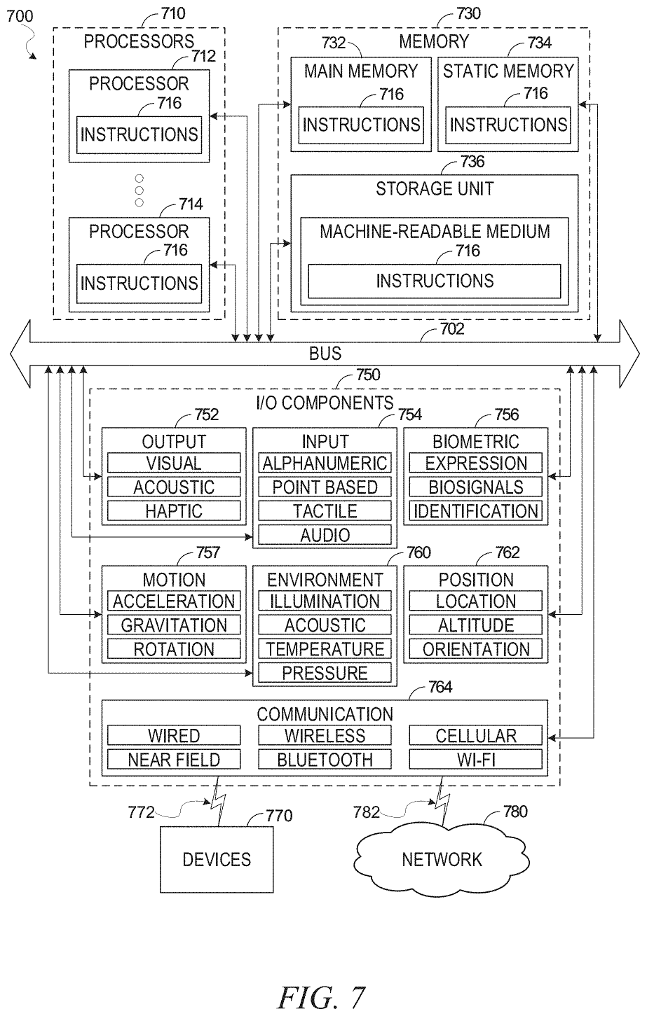

FIG. 6 is a block diagram 600 illustrating a software architecture 602, which can be installed on any one or more of the devices described above. FIG. 6 is merely a non-limiting example of a software architecture, and it will be appreciated that many other architectures can be implemented to facilitate the functionality described herein. In various embodiments, the software architecture 602 is implemented by hardware such as a machine 700 of FIG. 7 that includes processors 710, memory 730, and input/output (I/O) components 750. In this example architecture, the software architecture 602 can be conceptualized as a stack of layers where each layer may provide a particular functionality. For example, the software architecture 602 includes layers such as an operating system 604, libraries 606, frameworks 608, and applications 610. Operationally, the applications 610 invoke API calls 612 through the software stack and receive messages 614 in response to the API calls 612, consistent with some embodiments.

In various implementations, the operating system 604 manages hardware resources and provides common services. The operating system 604 includes, for example, a kernel 620, services 622, and drivers 624. The kernel 620 acts as an abstraction layer between the hardware and the other software layers, consistent with some embodiments. For example, the kernel 620 provides memory management, processor management (e.g., scheduling), component management, networking, and security settings, among other functionality. The services 622 can provide other common services for the other software layers. The drivers 624 are responsible for controlling or interfacing with the underlying hardware, according to some embodiments. For instance, the drivers 624 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 606 provide a low-level common infrastructure utilized by the applications 610. The libraries 606 can include system libraries 630 (e.g., C standard library) that can provide functions such as memory allocation functions, string manipulation functions, mathematic functions, and the like. In addition, the libraries 606 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 606 can also include a wide variety of other libraries 834 to provide many other APIs to the applications 610.

The frameworks 608 provide a high-level common infrastructure that can be utilized by the applications 610, according to some embodiments. For example, the frameworks 608 provide various graphic user interface (GUI) functions, high-level resource management, high-level location services, and so forth. The frameworks 608 can provide a broad spectrum of other APIs that can be utilized by the applications 610, some of which may be specific to a particular operating system 604 or platform.

In an example embodiment, the applications 610 include a home application 650, a contacts application 652, a browser application 654, a book reader application 656, a location application 658, a media application 660, a messaging application 662, a game application 664, and a broad assortment of other applications such as a third-party application 666. According to some embodiments, the applications 610 are programs that execute functions defined in the programs. Various programming languages can be employed to create one or more of the applications 610, structured in a variety of manners, such as object-oriented programming languages (e.g., Objective-C. Java, or C++) or procedural programming languages (e.g., C or assembly language). In a specific example, the third-party application 666 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 666 can invoke the API calls 612 provided by the operating system 604 to facilitate functionality described herein.

FIG. 7 illustrates a diagrammatic representation of a machine 700 in the form of a computer system within which a set of instructions may be executed for causing the machine 700 to perform any one or more of the methodologies discussed herein, according to an example embodiment. Specifically, FIG. 7 shows a diagrammatic representation of the machine 700 in the example form of a computer system, within which instructions 716 (e.g., software, a program, an application 610, an applet, an app, or other executable code) for causing the machine 700 to perform any one or more of the methodologies discussed herein may be executed. For example, the instructions 716 may cause the machine 700 to execute the method 500 of FIG. 5, Additionally, or alternatively, the instructions 716 may implement FIGS. 1-5, and so forth. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a PC, a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and 110 components 750, which may be configured to communicate with each other such as via a bus 702. In an example embodiment, the processors 710 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any, suitable combination thereof) may include, for example, a processor 712 and a processor 714 that may execute the instructions 716. The term “processor” is intended to include multi-core processors that may comprise two or more independent processors (sometimes referred to as “cores”) that may execute instructions 716 contemporaneously. Although FIG. 7 shows multiple processors 710, the machine 700 may include a single processor 712 with a single core, a single processor 712 with multiple cores (e.g., a multi-core processor 712), multiple processors 712, 714 with a single core, multiple processors 712, 714 with multiple cores, or any combination thereof.

The memory 730 may include a main memory 732, a static memory 734, and a storage unit 736, all accessible to the processors 710 such as via the bus 702. The main memory 732, the static memory 734, and the storage unit 736 store the instructions 716 embodying any one or more of the methodologies or functions described herein. The instructions 716 may also reside, completely or partially, within the main memory 732, within the static memory 734, within the storage unit 736, within at least one of the processors 710 (e.g., within the processor's cache memory), or any suitable combination thereof, during execution thereof by the machine 700.

The I/O components 750 may include a wide variety of components to receive input, provide output, produce output, transmit information, exchange information, capture measurements, and so on. The specific I/O components 750 that are included in a particular machine 700 will depend on the type of machine 700. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion, and the grouping is in no way limiting. In various example embodiments, the I/O components 750 may include output components 752 and input components 754. The output components 752 may include visual components (e.g., a display such as a plasma display panel (PDP), a light-emitting diode (LED) display; a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button 412, a touch screen that provides location and/or force of touches or touch gestures, or other tactile input components), audio input components (e.g., a microphone), and the like.

In further example embodiments, the I/O components 750 may include biometric components 756, motion components 757, environmental components 760, or position components 762, among a wide array of other components. For example; the biometric components 756 may include components to detect expressions (e.g., hand expressions, facial expressions, vocal expressions, body gestures, or eye tracking), measure biosignals e.g., blood pressure, heart rate, body temperature, perspiration, or brain waves), identify a person (e.g., voice identification, retinal identification, facial identification, fingerprint identification, or electroencephalogram-based identification), and the like. The motion components 757 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 762 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772, respectively. For example, the communication components 764 may include a network interface component or another suitable device to interface with the network 780. In further examples, the communication components 764 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a USB).

Moreover, the communication components 764 may detect identifiers or include components operable to detect identifiers. For example, the communication components 764 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes); or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories i.e., 730, 732, 734, and/or memory of the processor(s) 710) and/or the storage unit 736 may store one or more sets of instructions 716 and data structures (e.g., software) embodying or utilized by any one or more of the methodologies or functions described herein. These instructions (e.g., the instructions 716), when executed by the processor(s) 710, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 716 and/or data. The terms shall accordingly be taken to include, but not be limited to, solid-state memories, and optical and magnetic media, including memory internal or external to the processors 710. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 780 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 716 may be transmitted or received over the network 780 using a transmission medium via a network interface device (e.g., a network interface component included in the communication components 764) and utilizing any one of a number of well-known transfer protocols (e.g., HTTP). Similarly, the instructions 716 may be transmitted or received using a transmission medium via the coupling 772 (e.g., a peer-to-peer coupling) to the devices 770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 716 for execution by the machine 700, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A computer system, comprising:
one or more processors; and
a non-transitory computer readable storage medium storing instructions that, when executed by the one or more processors, cause the computer system to perform operations comprising:
causing the rendering of a graphical user interface on a display of a device;
receiving, via the graphical user interface, a selection of a first user profile by a viewer of the graphical user interface; the first user profile containing one or more attribute fields identifying attributes of a corresponding first user;
identifying one or more of the one or more attribute fields as query fields;
automatically generating a query using the one or more query fields;
performing a search for additional user profiles using the automatically generated query, resulting in one or more additional user profile results;
causing the graphical user interface to display summaries of a plurality of the additional user profile results across the display; and
causing the graphical user interface to render a button that, when selected by the viewer of the graphical user interface, causes a communication to be generated and sent to each of the displayed additional user profile results.

2. The computer system of claim 1, wherein the first user profile and the additional user profiles correspond to potential candidates for a job position as defined in a job posting stored in a job posting database, and wherein the automatically generating the query includes automatically generating a query using the one or more query fields without using information from the job posting to generate the query.

3. The computer system of claim 1, wherein the identifying one or more of the one or more attribute fields as query fields includes receiving, via the user interface, a selection of one or more attribute fields of the first user profile from the viewer.

4. The computer system of claim 1, wherein the identifying one or more of the one or more attribute fields as query fields includes using a machine-learned model to predict which of the one or more attribute fields are important to the viewer based on information about prior usage of the graphical user interface by the user.

5. The computer system of claim 1, wherein the query fields are predetermined.

6. The computer system of claim 5, wherein the query fields are selected from location, one or more skills, industry, and title.

7. The computer system of claim 6, wherein the one or more skills includes only a top skill.

8. A computerized method comprising:
causing the rendering of a graphical user interface on a display of a computer system;
receiving, via the graphical user interface, a selection of a first user profile by a viewer of the graphical user interface, the first user profile containing one or more attribute fields identifying attributes of a corresponding first user;
identifying one or more of the one or more attribute fields as query fields;
automatically generating a query using the one or more query fields;
performing a search for additional user profiles using the automatically generated query, resulting in one or more additional user profile results;
causing the graphical user interface to display summaries of a plurality of the additional user profile results across the display; and
causing the graphical user interface to render a button that, when selected by the viewer of the graphical user interface, causes a communication to be generated and sent to each of the displayed additional user profile results.

9. The computerized method of claim 8, wherein the first user profile and the additional user profiles correspond to potential candidates for a job position as defined in a job posting stored in a job posting database, and wherein the automatically generating the query includes automatically generating a query using the one or more query fields without using information from the job posting to generate the query.

10. The computerized method of claim 8, wherein the identifying one or more of the one or more attribute fields as query fields includes receiving, via the user interface, a selection of one or more attribute fields of the first user profile from the viewer.

11. The computerized method of claim 8, wherein the identifying one or more of the one or more attribute fields as query fields includes using a machine-learned model to predict which of the one or more attribute fields are important to the viewer based on information about prior usage of the graphical user interface by the user.

12. The computerized method of claim 8, wherein the query fields are predetermined.

13. The computerized method of claim 12, wherein e query fields are selected from location, one or more skills, industry, and title.

14. The computerized method of claim 13, wherein the one or more skills include only a top skill.

15. A non-transitory machine-readable storage medium comprising instructions that, when executed by one or more processors of a machine, cause the machine to perform operations comprising:
causing the rendering of a graphical user interface on a display of a computer system;
receiving, via the graphical user interface, a selection of a first user profile by a viewer of the graphical user interface, the first user profile containing one or more attribute fields identifying attributes of a corresponding first user;
identifying one or more of the one or more attribute fields as query fields;
automatically generating a query using the one or more query fields;
performing a search for additional user profiles using the automatically, generated query, resulting in one or more additional user profile results;
causing the graphical user interface to display summaries of a plurality of the additional user profile results across the display; and
causing the graphical user interface to render a button that, when selected by the viewer of the graphical user interface, causes a communication to be generated and sent to each of the displayed additional user profile results.

16. The non-transitory machine-readable storage medium of claim 15, wherein the first user profile and the additional user profiles correspond to potential candidates for a job position as defined in a job posting stored in a job posting database, and wherein the automatically generating the query includes automatically generating a query using the one or more query fields without using information from the job posting to generate the query.

17. The non-transitory machine-readable storage medium of claim 15, wherein the identifying one or more of the one or more attribute fields as query fields includes receiving, via the user interface, a selection of one or more attribute fields of the first user profile from the viewer.

18. The non-transitory machine-readable storage medium of claim 15, wherein the identifying one or more of the one or more attribute fields as query fields includes using a machine-learned model to predict which of the one or more attribute fields are important to the viewer based on information about prior usage of the graphical user interface by the user.

19. The non-transitory machine-readable storage medium of claim 15, wherein the query fields are predetermined.

20. The non-transitory machine-readable storage medium of claim 19, wherein the query fields are selected from location, one or more skills, industry, and title.
